(19) United States
(12) Patent Application Publication
(10) Pub. No.: US 2024/0192616 A1
(43) Pub. Date: Jun. 13, 2024

(54) PROCESS CARTRIDGE AND ELECTROPHOTOGRAPHIC APPARATUS

(71) Applicant: CANON KABUSHIKI KAISHA, Tokyo (JP)

(72) Inventors: FUMIYUKI HIYAMA, Shizuoka (JP); YUKA ISHIDUKA, Shizuoka (JP); AKIRA SAKAKIBARA, Shizuoka (JP); TSUTOMU NISHIDA, Shizuoka (JP); DAISUKE MIURA, Tokyo (JP)

(21) Appl. No.: 18/511,264

(22) Filed: Nov. 16, 2023

(30) Foreign Application Priority Data
Nov. 25, 2022 (JP) 2022-188612

(51) Int. Cl. G03G 5/147; G03G 9/097; G03G 21/18

(52) U.S. Cl. CPC G03G 5/14756; G03G 9/09725; G03G 21/1814

(57) ABSTRACT

Provided is a process cartridge integrally supporting an electrophotographic photosensitive member, a developing unit, and a cleaning unit, and being detachably attachable onto a main body of an electrophotographic apparatus. A surface layer of the electrophotographic photosensitive member comprises a polycarbonate resin having a structural unit represented by the formula (1), a structural unit represented by the formula (2), and a structural unit represented by the formula (3). Toner contains: a toner particle containing a resin; and an external additive. The external additive contains a particle of a silicon atom-containing compound, and a content ratio of the particle of the silicon atom-containing compound in the toner is 2.0 to 3.0 mass % with respect to a total mass of the toner. Also provided is an electrophotographic apparatus including the process cartridge.

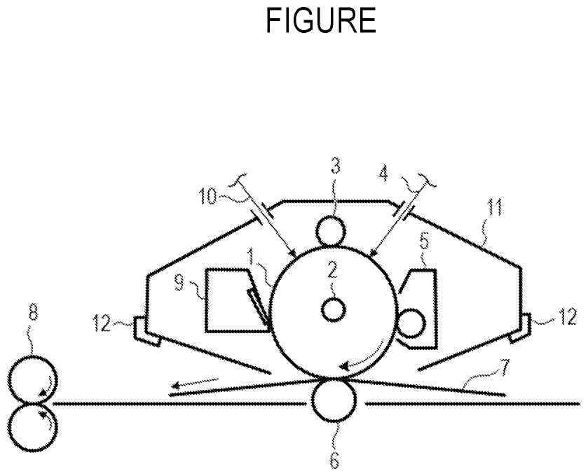

### BACKGROUND OF THE INVENTION

### Field of the Invention

The present disclosure relates to a process cartridge and an electrophotographic apparatus including a process cartridge.

### Description of the Related Art

An electrophotographic photosensitive member to be used in an electrophotographic apparatus is generally a drum-shaped electrophotographic photosensitive member. The electrophotographic photosensitive member having a drum shape (hereinafter also referred to as “electrophotographic photosensitive drum”) is generally used in an electrophotographic image forming process including a charging step, an exposing step, a developing step, a transferring step, and a cleaning step.

In the above-mentioned electrophotographic image forming process, the cleaning step of removing residual toner on the electrophotographic photosensitive drum after the transferring step is a step important in obtaining a clear image. A method of removing the residual toner in this cleaning step is generally a method including bringing a rubbery cleaning blade into pressure contact with the electrophotographic photosensitive drum to scrape off the toner. In recent years, in order to suppress the wear of the electrophotographic photosensitive drum, a method including performing the pressure contact under a state in which an abutting pressure of the cleaning blade is low is generally adopted.

A recent electrophotographic apparatus has been required to achieve a further reduction in torque (reduction in abutting pressure of its cleaning blade) and to be free from causing a cleaning failure.

In the cleaning step, a deposited layer of small particles called a blocking layer, the layer including, for example, the additive in toner, is formed at a portion in which the cleaning blade and the surface of the electrophotographic photosensitive drum are brought into abutment with each other. The maintenance of the blocking layer is important in the cleaning step.

The cleaning failure occurs when the blocking layer is broken by a certain factor to cause the toner or its external additive to escape from the cleaning blade. When the cleaning failure occurs, a streak-like image failure occurs on an image, or the fine toner or external additive that has escaped is present on the surface of the electrophotographic photosensitive drum even when no abnormality occurs on the image. As a result, in the charging step, the fine toner or external additive adheres to a charging roller to cause a problem such as a charging failure in some cases.

Although the toner can be suppressed from escaping by strengthening the abutting pressure of the cleaning blade, the wear of the electrophotographic photosensitive drum becomes vigorous, and hence the electrophotographic photosensitive drum cannot be subjected to long-term use.

In addition, in order to obtain high image quality during long-term use, high flowability of the toner is required to be maintained. When a silica particle is used as the external additive, flowability of the toner can be increased. Accordingly, a fogged image does not occur during long-term use, and hence high image quality can be kept. However, when the flowability of the toner is improved, the circulation of the toner occurs in a portion of the cleaning blade in front of the blocking layer, and hence a cleaning failure occurs in some cases.

In Japanese Patent Application Laid-Open No. 2012-83448, there is a disclosure of an image forming apparatus using an image bearing member (electrophotographic photosensitive member) including a surface layer including a polycarbonate resin and toner containing a fatty acid metal salt as an external additive. In Japanese Patent Application Laid-Open No. 2012-83448, there is a description that the use of the image forming apparatus having the above-mentioned configuration can smoothly cause wear of the surface of the image bearing member to suppress scraping unevenness, and as a result, the cleaning failure can be suppressed.

With the technology described in Japanese Patent Application Laid-Open No. 2012-83448, the abutting pressure of the related-art cleaning blade provides a suppressive effect on the cleaning failure. However, the configuration in which the abutting pressure of the cleaning blade is reduced in order to achieve a reduction in torque has had room for improvement in cleaning property.

### SUMMARY OF THE INVENTION

Accordingly, an object of the present disclosure is to provide a process cartridge that can achieve both of high image quality and a high cleaning property during long-term use, and an electrophotographic apparatus including the process cartridge.

The above-mentioned object is achieved by the present disclosure to be described below.

That is, a process cartridge according to one aspect of the present disclosure is a process cartridge including: an electrophotographic photosensitive member comprising a surface layer; a developing unit configured to develop an electrostatic latent image formed on a surface of the electrophotographic photosensitive member with toner to form a toner image on the surface of the electrophotographic photosensitive member; and a cleaning unit configured to remove the toner remaining on the surface of the electrophotographic photosensitive member with a cleaning blade after the toner image is transferred to a transfer material, the process cartridge integrally supporting the electrophotographic photosensitive member, the developing unit, and the cleaning unit, and being detachably attachable onto a main body of an electrophotographic apparatus, wherein the surface layer of the electrophotographic photosensitive member comprises a polycarbonate resin having a structural unit represented by the following formula (1), a structural unit represented by the following formula (2), and a structural unit represented by the following formula (3), wherein the toner contains: a toner particle containing a resin; and an external additive, wherein the external additive contains a particle of a silicon atom-containing compound, and wherein a content ratio of the particle of the silicon atom-containing compound in the toner is 2.0 to 3.0 mass % with respect to a total mass of the toner.

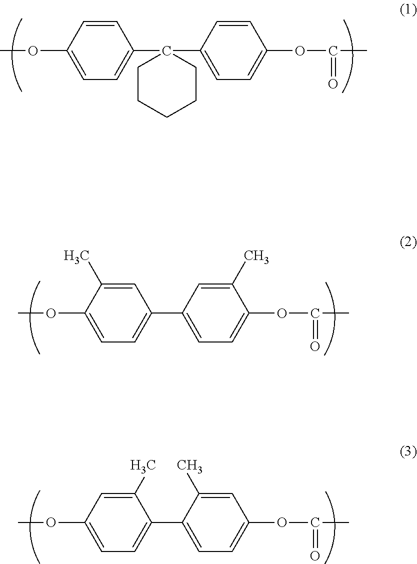

Further, an electrophotographic apparatus according to another aspect of the present disclosure includes the above-mentioned process cartridge.

Further features of the present invention will become apparent from the following description of exemplary embodiments with reference to the attached drawing.

### BRIEF DESCRIPTION OF THE DRAWINGS

FIGURE is a schematic view for illustrating an example of the schematic configuration of a process cartridge and an electrophotographic apparatus according to the present disclosure.

### DESCRIPTION OF THE EMBODIMENTS

The present disclosure is described in detail below by way of a preferred embodiment.

The inventors have made extensive investigations, and as a result, have found that the above-mentioned problems can be solved by a process cartridge having the following configuration.

Specifically, a process cartridge according to the present disclosure integrally supports an electrophotographic photosensitive member including a surface layer, a developing unit, and a cleaning unit, and is detachably attachable onto a main body of an electrophotographic apparatus.

The developing unit is configured to develop an electrostatic latent image formed on a surface of the electrophotographic photosensitive member with toner to form a toner image on the surface of the electrophotographic photosensitive member. In addition, the cleaning unit is configured to remove the toner remaining on the surface of the electrophotographic photosensitive member with a cleaning blade after the toner image is transferred to a transfer material.

In addition, the surface layer of the electrophotographic photosensitive member includes a polycarbonate resin having a structural unit represented by the following formula (1), a structural unit represented by the following formula (2), and a structural unit represented by the following formula (3).

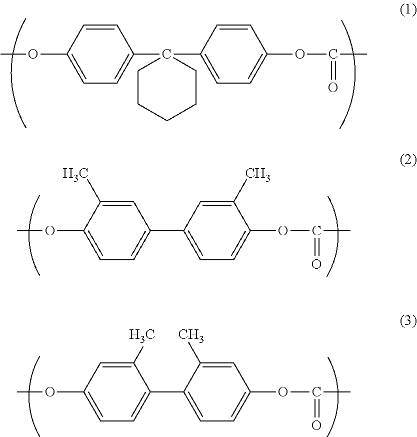

Further, the toner contains: a toner particle containing a resin; and an external additive.

In addition, the external additive contains a particle of a silicon atom-containing compound, and a content ratio of the particle of the silicon atom-containing compound in the toner is 2.0 to 3.0 mass % with respect to a total mass of the toner.

The inventors have conceived the mechanism via which the process cartridge having the above-mentioned configuration is effective in achieving both of high image quality and a high cleaning property during long-term use to be as described below.

When the toner containing the particle of the silicon atom-containing compound as the external additive is used, high image quality can be stably maintained during long-term use. Meanwhile, however, the external additive has high flowability, and hence the toner moves so as to circulate in front of a deposited layer formed at a portion in which the cleaning blade and the surface of the electrophotographic photosensitive member are brought into abutment with each other. Thus, the fine toner and its external additive leak from an opening in the cleaning blade in some cases. As a result, a streak-like image failure occurs in some cases.

The inventors have made an investigation, and as a result, have found that when the surface layer of the electrophotographic photosensitive member includes a polycarbonate resin having the above-mentioned structural units, the circulation force of the toner in front of the deposited layer is reduced, and hence a cleaning property is improved. The inventors have assumed the reason why the cleaning property is improved to be as described below.

Cleaning generally causes wear on a surface of the surface layer including the polycarbonate resin. The surface layer being scraped off by the wear to become a powder (hereinafter referred to as “scraped powder”) is also finally recovered by the cleaning blade, but the powder is mixed with the toner or its external additive in front of the portion in which the cleaning blade and the electrophotographic photosensitive member are brought into abutment with each other. In the present disclosure, it is assumed that the escape of the toner is suppressed because the interaction between the toner surface and the external additive is improved by the scraped powder, and the flowability is reduced by lumping up of the toner with a three-dimensional action of the polycarbonate resin having the above-mentioned structural units.

As described in the foregoing mechanism, when the respective configurations of the electrophotographic photosensitive member and the toner synergistically affect each other in the process cartridge according to one aspect of the present disclosure, an effect according to the present disclosure can be achieved.

The configuration of the electrophotographic photosensitive member of the process cartridge according to one aspect of the present disclosure is described in detail below.

### [Electrophotographic Photosensitive Member]

The electrophotographic photosensitive member of the present disclosure includes a surface layer.

A method of producing the electrophotographic photosensitive member of the present disclosure is, for example, a method involving: preparing coating liquids for the respective layers to be described later; applying the liquids in a desired order of the layers; and drying the liquids. In this case, examples of the method of applying the coating liquid include dip coating, spray coating, inkjet coating, roll coating, die coating, blade coating, curtain coating, wire bar coating, and ring coating. Of those, dip coating is preferred from the viewpoints of efficiency and productivity.

A support and the respective layers are described below.

### <Support>

In the present disclosure, the electrophotographic photosensitive member includes the support. In the present disclosure, the support is preferably an electroconductive support having electroconductivity. In addition, examples of the shape of the support include a cylindrical shape, a belt shape, and a sheet shape. A support having a cylindrical shape out of those shapes is preferred. In addition, the surface of the support may be subjected to, for example, electrochemical treatment such as anodization, blast treatment, or cutting treatment.

A metal, a resin, glass, or the like is preferred as a material for the support.

Examples of the metal include aluminum, iron, nickel, copper, gold, stainless steel, and alloys thereof. An aluminum support using aluminum out of those metals is preferred.

In addition, electroconductivity may be imparted to the resin or the glass through treatment involving, for example, mixing or coating the resin or the glass with an electroconductive material.

### <Electroconductive Layer>

In the present disclosure, an electroconductive layer may be arranged on the support. The arrangement of the electroconductive layer can conceal a flaw and unevenness on the surface of the support, and can control the reflection of light on the surface of the support.

The electroconductive layer preferably contains electroconductive particles and a resin.

A material for the electroconductive particles is, for example, a metal oxide, a metal, or carbon black.

Examples of the metal oxide include zinc oxide, aluminum oxide, indium oxide, silicon oxide, zirconium oxide, tin oxide, titanium oxide, magnesium oxide, antimony oxide, and bismuth oxide. Examples of the metal include aluminum, nickel, iron, nichrome, copper, zinc, and silver.

Of those, the metal oxide is preferably used as the electroconductive particles. In particular, titanium oxide, tin oxide, or zinc oxide is more preferably used.

When the metal oxide is used as the electroconductive particles, the surface of the metal oxide may be treated with a silane coupling agent or the like, or the metal oxide may be doped with an element, such as phosphorus or aluminum, or an oxide thereof.

In addition, the electroconductive particles may each have a laminated configuration including a core particle and a covering layer covering the core particle. A material for the core particle is, for example, titanium oxide, barium sulfate, or zinc oxide. A material for the covering layer is, for example, a metal oxide such as tin oxide.

In addition, when the metal oxide is used as the electroconductive particles, the volume-average particle diameter of the particles is preferably 1 to 500 nm, more preferably 3 to 400 nm.

Examples of the resin include a polyester resin, a polycarbonate resin, a polyvinyl acetal resin, an acrylic resin, a silicone resin, an epoxy resin, a melamine resin, a polyurethane resin, a phenol resin, and an alkyd resin.

In addition, the electroconductive layer may further contain, for example, a concealing agent, such as a silicone oil, resin particles, or titanium oxide.

The thickness of the electroconductive layer is preferably 1 to 50 μm, particularly preferably 3 to 40 μm.

The electroconductive layer may be formed by: preparing a coating liquid for an electroconductive layer containing the above-mentioned respective materials and a solvent; forming a coating film of the coating liquid; and drying the coating film. Examples of the solvent to be used in the coating liquid include an alcohol-based solvent, a sulfoxide-based solvent, a ketone-based solvent, an ether-based solvent, an ester-based solvent, and an aromatic hydrocarbon-based solvent. A dispersion method for the dispersion of the electroconductive particles in the coating liquid for an electroconductive layer is, for example, a method including using a paint shaker, a sand mill, a ball mill, or a liquid collision-type high-speed dispersing machine.

### <Undercoat Layer>

In the present disclosure, an undercoat layer may be arranged on the support or the electroconductive layer. The arrangement of the undercoat layer can improve an adhesive function between layers to impart a charge injection-inhibiting function.

The undercoat layer preferably contains a resin. In addition, the undercoat layer may be formed as a cured film by polymerizing a composition containing a monomer having a polymerizable functional group.

Examples of the resin include a polyester resin, a polycarbonate resin, a polyvinyl acetal resin, an acrylic resin, an epoxy resin, a melamine resin, a polyurethane resin, a phenol resin, a polyvinyl phenol resin, an alkyd resin, a polyvinyl alcohol resin, a polyethylene oxide resin, a polypropylene oxide resin, a polyamide resin, a polyamic acid resin, a polyimide resin, a polyamide imide resin, and a cellulose resin.

Examples of the polymerizable functional group of the monomer having the polymerizable functional group include an isocyanate group, a blocked isocyanate group, a methylol group, an alkylated methylol group, an epoxy group, a metal alkoxide group, a hydroxyl group, an amino group, a carboxy group, a thiol group, a carboxylic acid anhydride group, and a carbon-carbon double bond group.

In addition, the undercoat layer may further contain an electron transporting substance, a metal oxide, a metal, an electroconductive polymer, and the like for the purpose of improving electric characteristics. Of those, an electron transporting substance and a metal oxide are preferably used.

Examples of the electron transporting substance include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-containing compound. An electron transporting substance having a polymerizable functional group may be used as the electron-transporting material and copolymerized with the above-mentioned monomer having a polymerizable functional group to form the undercoat layer as a cured film.

Examples of the metal oxide include indium tin oxide, tin oxide, indium oxide, titanium oxide, zinc oxide, aluminum oxide, and silicon dioxide. Examples of the metal include gold, silver, and aluminum.

In addition, the undercoat layer may further contain an additive.

The thickness of the undercoat layer is preferably 0.1 to 50 μm, more preferably 0.2 to 40 μm, particularly preferably 0.3 to 30 μm.

The undercoat layer may be formed by: preparing a coating liquid for an undercoat layer containing the above-mentioned respective materials and a solvent; forming a coating film of the coating liquid; and drying and/or curing the coating film. Examples of the solvent to be used in the coating liquid include an alcohol-based solvent, a ketone-based solvent, an ether-based solvent, an ester-based solvent, and an aromatic hydrocarbon-based solvent.

### <Photosensitive Layer>

The photosensitive layer of the electrophotographic photosensitive member is mainly classified into (1) a laminate type photosensitive layer and (2) a monolayer type photosensitive layer. (1) The laminate type photosensitive layer includes a charge generating layer containing a charge generating substance and a charge transporting layer containing a charge transporting substance. (2) The monolayer type photosensitive layer includes a photosensitive layer containing both of the charge generating substance and the charge transporting substance. The surface layer of the present disclosure refers to the charge transporting layer and the monolayer type photosensitive layer itself in the cases of (1) and (2), respectively.

### (1) Laminate Type Photosensitive Layer

The laminate type photosensitive layer includes the charge generating layer and the charge transporting layer.

### (1-1) Charge Generating Layer

The charge generating layer preferably contains the charge generating substance and a resin.

Examples of the charge generating substance include an azo pigment, a perylene pigment, a polycyclic quinone pigment, an indigo pigment, and a phthalocyanine pigment. Of those, an azo pigment and a phthalocyanine pigment are preferred. Of the phthalocyanine pigments, an oxytitanium phthalocyanine pigment, a chlorogallium phthalocyanine pigment, and a hydroxygallium phthalocyanine pigment are preferred.

The content of the charge generating substance in the charge generating layer is preferably 40 to 85 mass %, more preferably 60 to 80 mass % with respect to the total mass of the charge generating layer.

Examples of the resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin, and a polyvinyl chloride resin. Of those, a polyvinyl butyral resin is preferred.

In addition, the charge generating layer may further contain an additive, such as an antioxidant or a UV absorber. Specific examples thereof include a hindered phenol compound, a hindered amine compound, a sulfur compound, a phosphorus compound, and a benzophenone compound.

The thickness of the charge generating layer is preferably 0.1 to 1 μm, more preferably 0.15 to 0.4 μm.

The charge generating layer may be formed by: preparing a coating liquid for a charge generating layer containing the above-mentioned respective materials and a solvent; forming a coating film of the coating liquid; and drying the coating film. Examples of the solvent to be used in the coating liquid include an alcohol-based solvent, a sulfoxide-based solvent, a ketone-based solvent, an ether-based solvent, an ester-based solvent, and an aromatic hydrocarbon-based solvent.

### (1-2) Charge Transporting Layer

The charge transporting layer (surface layer) preferably contains the charge transporting substance and a resin.

Examples of the charge transporting substance include a polycyclic aromatic compound, a heterocyclic compound, a hydrazone compound, a styryl compound, an enamine compound, a benzidine compound, a triarylamine compound, and a resin having a group derived from any of those substances. Of those, a triarylamine compound and a benzidine compound are preferred because the compounds each have a high suppressive effect on the occurrence of a black spot.

The structures of CTM1 to CTM10 as preferred examples of the charge transporting substance are shown below.

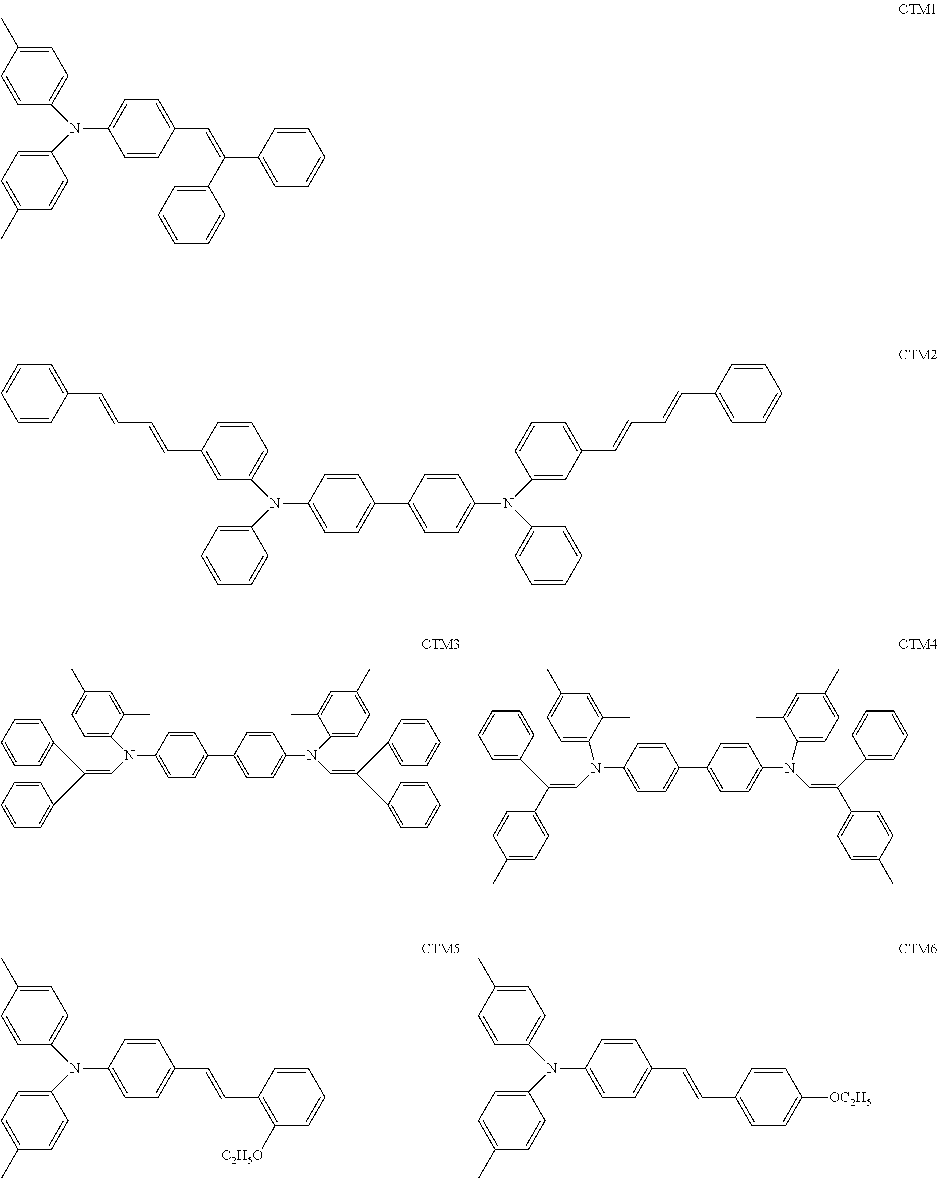

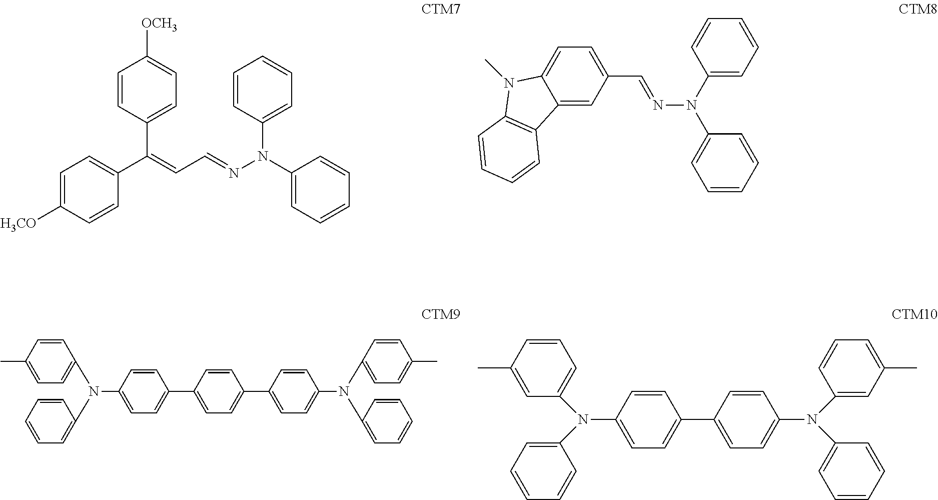

The content of the charge transporting substance in the charge transporting layer is preferably 25 to 70 mass %, more preferably 30 to 55 mass % with respect to the total mass of the charge transporting layer.

In the present disclosure, the charge transporting layer includes the polycarbonate resin having the structural unit represented by the following formula (1), the structural unit represented by the following formula (2), and the structural unit represented by the following formula (3).

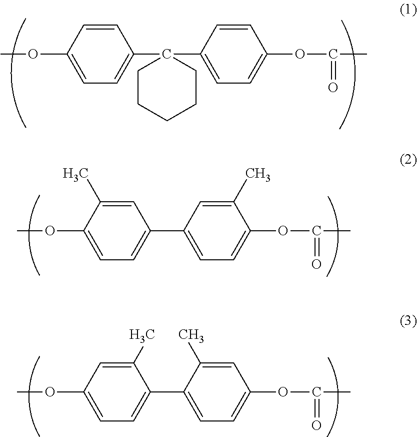

In addition, in the present disclosure, a total ion chromatogram (TIC) obtained by subjecting a polymer component recovered from the charge transporting layer to pyrolysis-gas chromatography-mass spectrometry under coexistence with tetramethylammonium hydroxide (TMAH) has such mass spectra as described below. That is, the TIC has a mass spectrum including components satisfying m/z=242 and m/z=227, and a mass spectrum including components satisfying m/z=296, m/z=253, m/z=145, and m/z=121. Further, the polymer component has peaks at 2.35±0.02 ppm and 2.40±0.02 ppm in a ¹H-nuclear magnetic resonance spectrum (NMR spectrum) with deuterated chloroform.

The fact that the TIC has the mass spectrum including the components satisfying m/z=242 and m/z=227 corresponds to the fact that the polycarbonate resin in the charge transporting layer has at least any one of the structural unit represented by the above-mentioned formula (2) and the structural unit represented by the above-mentioned formula (3). In addition, the fact that the TIC has the mass spectrum including the components satisfying m/z=296, m/z=253, m/z=145, and m/z=121 corresponds to the fact that the polycarbonate resin in the charge transporting layer has the structural unit represented by the above-mentioned formula (1).

In addition, the fact that the ¹H-NMR spectrum has a peak at 2.35±0.02 ppm corresponds to the fact that the polycarbonate resin in the charge transporting layer has the structural unit represented by the above-mentioned formula (2). In addition, the fact that the ¹H-NMR spectrum has a peak at 2.40±0.02 ppm corresponds to the fact that the polycarbonate resin in the charge transporting layer has the structural unit represented by the above-mentioned formula (3).

In the above-mentioned polycarbonate resin, it is preferred that the content ratio of the structural unit represented by the formula (2) be 40 to 60 mol % with respect to the total of the content of the structural unit represented by the formula (2) and the content of the structural unit represented by the formula (3).

In addition, in the above-mentioned polycarbonate resin, it is preferred that the total content ratio of the content of the structural unit represented by the formula (2) and the content of the structural unit represented by the formula (3) be 40 to 60 mol % with respect to the total of the content of the structural unit represented by the formula (1), the content of the structural unit represented by the formula (2), and the content of the structural unit represented by the formula (3).

Specific examples of the methods for the recovery of the polymer component from the charge transporting layer, and the pyrolysis-gas chromatography-mass spectrometry (pyrolysis GCMS) and the NMR measurement using the recovered polymer component are described below.

### <Recovery of Polymer Component From Charge Transporting Layer>

The recovery of the polymer component from the charge transporting layer is performed by reprecipitation of the resin in the charge transporting layer by the following procedure.

### 1. Cutting of Electrophotographic Photosensitive Member

The electrophotographic photosensitive member is cut at a position 10 cm from an end portion of the electrophotographic photosensitive member in the generating line direction with a scroll saw.

### 2. Washing of Inner Surface of 10 cm Electrophotographic Photosensitive Member Having Been Cut Out

An inner surface of the electrophotographic photosensitive member is wiped with lens-cleaning paper impregnated with chloroform.

### 3. Elution of Charge Transporting Layer

3 cm of an end portion of the electrophotographic photosensitive member on a cut surface side is immersed in chloroform.

Specifically, about 60 cc of chloroform is loaded into a 100 mL beaker, and the immersion is performed at normal temperature for 5 minutes.

### 4. Concentration (Preparing Heavy Solution)

The resultant is concentrated to 2 mL with a rotary evaporator.

### 5. Reprecipitation

50 mL of a methanol/acetone mixed liquid (volume ratio: 1:1) is prepared, and the whole amount of the heavy solution is dropped thereinto under stirring.

### 6. Filtration

A paper filter (No. 5C-40, manufactured by Kiriyama Glass Co.) was set to a Kiriyama funnel (SU-40, manufactured by Kiriyama Glass Co.), and suction filtration is performed.

### 7. Drying

The residue on the paper filter is recovered with a spatula and subjected to vacuum drying (70° C., 1 hour).

### <Pyrolysis GCMS>

Apparatus configuration: Pyrolyzer+gas chromatography (GC) apparatus+mass spectrometry (MS) apparatus
Pyrolyzer: JPS-700 manufactured by Japan Analytical Industry Co., Ltd.
GC apparatus: FOCUS GC manufactured by Thermo Fisher Scientific K.K.
MS apparatus: ISQ manufactured by Thermo Fisher Scientific K.K.
Sample amount: 0.1 mg (containing TMAH (manufactured by Tama Chemicals Co., Ltd.))
Pyrolysis temperature: 590° C. (using Pyrofoil F590 manufactured by Japan Analytical Industry Co., Ltd.)
Column: “HP5-MS” (19091S-433 manufactured by Agilent Technologies Japan, Ltd., length: 30 m, inner diameter: 0.25 mm, film thickness: 0.25 μm)
GC inlet conditions: Inlet Temp: 250° C.
   Split Flow: 50 mL/min
GC temperature increase conditions: 40° C. (5 min)→10° C./min)(300° C.)→300° C. (20 min)
MS conditions: Ion Source Temp: 200° C.
   MS Transfer Line Temp: 250° C.

### <NMR Measurement>

### Measurement Sample Preparation

20 mg of a sample is dissolved into 1 g of deuterated chloroform containing tetramethylsilane serving as a reference substance, and the whole amount thereof is transferred to an NMR tube. As the deuterated chloroform, there may be used, for example, deuterated chloroform (manufactured by Sigma-Aldrich Japan G.K., chloroform-d, model number: 612200). In addition, as the NMR tube, there may be used an NMR tube (manufactured by Norell, Inc., ST500-7, model number: S3010).

NMR measurement
Apparatus: AVANCE 500 manufactured by Bruker
Conditions: Proton NMR, automatic measurement by Icon-NMR
Number of scans: 32
Reference peak: The peak of a methyl group of tetramethylsilane is set as 0 ppm.

A content ratio (charge transporting substance: resin) between the charge transporting substance and the resin is preferably within the range of from 4:10 to 20:10, more preferably within the range of from 5:10 to 10:10 in mass ratio.

In addition, the charge transporting layer may contain an additive, such as an antioxidant, a UV absorber, a plasticizer, a leveling agent, a slipperiness-imparting agent, or a wear resistance-improving agent.

Specific examples of the additive include a hindered phenol compound, a hindered amine compound, a sulfur compound, a phosphorus compound, a benzophenone compound, a siloxane-modified resin, a silicone oil, fluorine resin particles, polystyrene resin particles, polyethylene resin particles, silica particles, alumina particles, and boron nitride particles. Of those, silica particles are preferred from the viewpoint of scratch resistance. In addition, the volume-average particle diameter of the silica particles is preferably 0.1 to 0.5 μm because, in the charge transporting layer in the configuration according to the present disclosure, an external impact is easily absorbed and a scratch can be suppressed.

The thickness of the charge transporting layer is preferably 5 to 50 μm, more preferably 8 to 40 μm, particularly preferably 10 to 30 μm.

The charge transporting layer may be formed by: preparing a coating liquid for a charge transporting layer containing the above-mentioned respective materials and a solvent; forming a coating film of the coating liquid; and drying the coating film. Examples of the solvent to be used in the coating liquid include an alcohol-based solvent, a ketone-based solvent, an ether-based solvent, an ester-based solvent, and an aromatic hydrocarbon-based solvent. Of those solvents, an ether-based solvent or an aromatic hydrocarbon-based solvent is preferred.

### (2) Monolayer Type Photosensitive Layer

The monolayer type photosensitive layer may be formed by: preparing a coating liquid for a photosensitive layer containing the charge generating substance, the charge transporting substance, a resin, and a solvent; forming a coating film of the coating liquid; and drying the coating film. The charge generating substance, the charge transporting substance, and the resin are the same as the examples of the materials in the above-mentioned section “(1) Laminate Type Photosensitive Layer.” The monolayer type photosensitive layer is a surface layer, and includes the polycarbonate resin having the structural unit represented by the formula (1), the structural unit represented by the formula (2), and the structural unit represented by the formula (3) in the same manner as that described in the above-mentioned section “(1-2) Charge Transporting Layer.”

Subsequently, the toner to be used in the configuration according to the present disclosure is described in detail below.

### <Method of Producing Toner>

A method of producing toner particles is described.

A known method may be used as the method of producing toner particles, and a kneading and pulverization method or a wet production method may be used. From the viewpoints of uniformization of particle diameters and shape controllability, the wet production method may be preferably used. Further, examples of the wet production method may include a suspension polymerization method, a dissolution suspension method, an emulsion polymerization aggregation method, and an emulsion aggregation method, and the emulsion aggregation method may be preferably used.

In the emulsion aggregation method, materials, such as particles of a binder resin and particles of a colorant, are first dispersed and mixed in an aqueous medium containing a dispersion stabilizer. A surfactant may be added to the aqueous medium. After that, aggregation is performed by adding an aggregating agent until desired particle diameters of the toner particles are obtained, and after, or simultaneously with, the aggregation, the resin particles are fused together. Further, as required, thermal shape control is performed to form toner particles.

Here, the particles of the binder resin may be composite particles each formed of a plurality of layers having a configuration of two or more layers of resins with different compositions. For example, the particles may be produced by an emulsion polymerization method, a mini-emulsion polymerization method, or a phase-transfer emulsification method, or may be produced by a combination of several production methods.

When an internal additive such as a colorant is incorporated into the toner particles, the internal additive may be incorporated into resin particles. Alternatively, a dispersion liquid of internal additive particles formed only of the internal additive may be separately prepared, and the internal additive particles may be aggregated together when the resin particles are aggregated.

In addition, toner particles each having a configuration of layers with different compositions may be prepared by adding resin particles with different compositions with a time difference at the time of aggregation, followed by aggregation.

The following dispersion stabilizers may each be used as the dispersion stabilizer.

As an inorganic dispersion stabilizer, there are given tricalcium phosphate, magnesium phosphate, zinc phosphate, aluminum phosphate, calcium carbonate, magnesium carbonate, calcium hydroxide, magnesium hydroxide, aluminum hydroxide, calcium metasilicate, calcium sulfate, barium sulfate, bentonite, silica, and alumina.

In addition, as an organic dispersion stabilizer, there are given polyvinyl alcohol, gelatin, methylcellulose, methylhydroxypropylcellulose, ethylcellulose, carboxymethylcellulose sodium salt, and starch.

A known cationic surfactant, anionic surfactant, or nonionic surfactant may be used as the surfactant.

Specific examples of the cationic surfactant include dodecylammonium bromide, dodecyltrimethylammonium bromide, dodecylpyridinium chloride, dodecylpyridinium bromide, and hexadecyltrimethylammonium bromide.

Specific examples of the nonionic surfactant include dodecyl polyoxyethylene ether, hexadecyl polyoxyethylene ether, nonylphenyl polyoxyethylene ether, lauryl polyoxyethylene ether, sorbitan monooleate polyoxyethylene ether, styrylphenyl polyoxyethylene ether, and monodecanoyl sucrose.

Specific examples of the anionic surfactant may include aliphatic soaps, such as sodium stearate and sodium laurate, sodium lauryl sulfate, sodium dodecylbenzene sulfonate, and sodium polyoxyethylene (2) lauryl ether sulfate.

### <Binder Resin>

A binder resin for forming the toner particles is described.

Suitable examples of the binder resin may include a vinyl-based resin and a polyester resin.

Examples of the vinyl-based resin, the polyester resin, and the other binder resins may include the following resins or polymers:

homopolymers of styrene and substituted styrenes, such as polystyrene and polyvinyltoluene; styrene-based copolymers, such as a styrene-propylene copolymer, a styrene-vinyltoluene copolymer, a styrene-vinylnaphthalene copolymer, a styrene-methyl acrylate copolymer, a styrene-ethyl acrylate copolymer, a styrene-butyl acrylate copolymer, a styrene-octyl acrylate copolymer, a styrene-dimethylaminoethyl acrylate copolymer, a styrene-methyl methacrylate copolymer, a styrene-ethyl methacrylate copolymer, a styrene-butyl methacrylate copolymer, a styrene-dimethylaminoethyl methacrylate copolymer, a styrene-vinyl methyl ether copolymer, a styrene-vinyl ethyl ether copolymer, a styrene-vinyl methyl ketone copolymer, a styrene-butadiene copolymer, a styrene-isoprene copolymer, a styrene-maleic acid copolymer, and a styrene-maleate copolymer; and polymethyl methacrylate, polybutyl methacrylate, polyvinyl acetate, polyethylene, polypropylene, polyvinyl butyral, a silicone resin, a polyamide resin, an epoxy resin, a polyacrylic resin, a rosin, a modified rosin, a terpene resin, a phenol resin, an aliphatic or alicyclic hydrocarbon resin, and an aromatic petroleum resin. Those binder resins may be used alone or as a mixture thereof.

The binder resin preferably contains a carboxy group, and is preferably a resin produced by using a polymerizable monomer containing a carboxy group. Examples thereof include: vinylcarboxylic acids, such as acrylic acid, methacrylic acid, α-ethyl acrylic acid, and crotonic acid; unsaturated dicarboxylic acids, such as fumaric acid, maleic acid, citraconic acid, and itaconic acid; and unsaturated dicarboxylic acid monoester derivatives, such as monoacryloyloxyethyl succinate, monomethacryloyloxyethyl succinate, monoacryloyloxyethyl phthalate, and monomethacryloyloxyethyl phthalate.

Condensation polymerization products of the following carboxylic acid components and alcohol components may each be used as the polyester resin. Examples of the carboxylic acid component include terephthalic acid, isophthalic acid, phthalic acid, fumaric acid, maleic acid, cyclohexanedicarboxylic acid, and trimellitic acid. Examples of the alcohol component include bisphenol A, hydrogenated bisphenol, an ethylene oxide adduct of bisphenol A, a propylene oxide adduct of bisphenol A, glycerin, trimethylolpropane, and pentaerythritol.

In addition, the polyester resin may be a polyester resin containing a urea group. It is preferred that a carboxy group at, for example, a terminal of the polyester resin be not capped.

### <Crosslinking Agent>

A crosslinking agent may be added at the time of the polymerization of the polymerizable monomer for controlling the molecular weight of the binder resin for forming the toner particles.

Examples thereof include ethylene glycol dimethacrylate, ethylene glycol diacrylate, diethylene glycol dimethacrylate, diethylene glycol diacrylate, triethylene glycol dimethacrylate, triethylene glycol diacrylate, neopentyl glycol dimethacrylate, neopentyl glycol diacrylate, divinylbenzene, bis(4-acryloyloxypolyethoxyphenyl)propane, ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, diethylene glycol diacrylate, triethylene glycol diacrylate, tetraethylene glycol diacrylate, diacrylates of polyethylene glycol #200, #400, and #600, dipropylene glycol diacrylate, polypropylene glycol diacrylate, and a polyester-type diacrylate (MANDA, Nippon Kayaku Co., Ltd.), and compounds obtained by changing those acrylates to methacrylates.

The addition amount of the crosslinking agent is preferably 0.001 to 15.000 parts by mass with respect to 100 parts by mass of the polymerizable monomer.

### <Releasing Agent>

It is preferred that a releasing agent be incorporated as one of the materials for forming the toner particles. In particular, when an ester wax having a melting point of 60 to 90° C. is used as the releasing agent, a plasticizing effect is easily obtained because of the excellent compatibility of the ester wax with the binder resin.

Examples of the ester wax include: waxes each including a fatty acid ester as a main component, such as a carnauba wax and a montanic acid ester wax; a wax obtained by removing part or the whole of an acid component from a fatty acid ester such as a deacidified carnauba wax; a methyl ester compound having a hydroxy group obtained by, for example, hydrogenating a plant oil and fat; saturated fatty acid monoesters, such as stearyl stearate and behenyl behenate; diesterified products of a saturated aliphatic dicarboxylic acid and a saturated aliphatic alcohol, such as dibehenyl sebacate, distearyl dodecanedioate, and distearyl octadecanedioate; and diesterified products of a saturated aliphatic diol and a saturated aliphatic monocarboxylic acid, such as nonanediol dibehenate and dodecanediol distearate.

Of those waxes, a bifunctional ester wax (diester) having two ester bonds in a molecular structure thereof is preferably used.

The bifunctional ester wax is an ester compound of a dihydric alcohol and an aliphatic monocarboxylic acid, or an ester compound of a divalent carboxylic acid and an aliphatic monoalcohol.

Specific examples of the aliphatic monocarboxylic acid include myristic acid, palmitic acid, stearic acid, arachidic acid, behenic acid, lignoceric acid, cerotic acid, montanic acid, melissic acid, oleic acid, vaccenic acid, linoleic acid, and linolenic acid.

Specific examples of the aliphatic monoalcohol include myristyl alcohol, cetanol, stearyl alcohol, arachidyl alcohol, behenyl alcohol, tetracosanol, hexacosanol, octacosanol, and triacontanol.

Specific examples of the divalent carboxylic acid include butanedioic acid (succinic acid), pentanedioic acid (glutaric acid), hexanedioic acid (adipic acid), heptanedioic acid (pimelic acid), octanedioic acid (suberic acid), nonanedioic acid (azelaic acid), decanedioic acid (sebacic acid), dodecanedioic acid, tridecanedioic acid, tetradecanedioic acid, hexadecanedioic acid, octadecanedioic acid, eicosanedioic acid, phthalic acid, isophthalic acid, and terephthalic acid.

Specific examples of the dihydric alcohol include ethylene glycol, propylene glycol, 1,3-propanediol, 1,4-butanediol, 1,5-pentanediol, 1,6-hexanediol, 1,10-decanediol, 1,12-dodecanediol, 1,14-tetradecanediol, 1,16-hexadecanediol, 1,18-octadecanediol, 1,20-eicosanediol, 1,30-triacontanediol, diethylene glycol, dipropylene glycol, 2,2,4-trimethyl-1,3-pentanediol, neopentyl glycol, 1,4-cyclohexane dimethanol, spiroglycol, 1,4-phenylene glycol, bisphenol A, and hydrogenated bisphenol A.

Examples of the other releasing agent that may be used include: a petroleum-based wax, such as a paraffin wax, a microcrystalline wax, or petrolatum, and derivatives thereof; a montan wax and derivatives thereof; a hydrocarbon-based wax obtained by a Fischer-Tropsch method and derivatives thereof; a polyolefin wax, such as polyethylene or polypropylene, and derivatives thereof; a natural wax, such as a carnauba wax or a candelilla wax, and derivatives thereof; a higher aliphatic alcohol; and a fatty acid, such as stearic acid or palmitic acid, or compounds thereof.

The content of the releasing agent is preferably 5.0 to 20.0 parts by mass with respect to 100.0 parts by mass of the binder resin or the polymerizable monomer.

### <Colorant>

When a colorant is incorporated into the toner particles, the colorant is not particularly limited, and known colorants including the following examples may be used.

As yellow pigments, there are used yellow iron oxide, Naples yellow, Naphthol Yellow S, condensed azo compounds, such as Hansa Yellow G, Hansa Yellow 10G, Benzidine Yellow G, Benzidine Yellow GR, quinoline yellow lake, Permanent Yellow NCG, and tartrazine lake, isoindolinone compounds, anthraquinone compounds, azo metal complexes, methine compounds, and allyl amide compounds. Specific examples thereof include the following pigments:
C.I. Pigment Yellow 12, 13, 14, 15, 17, 62, 74, 83, 93, 94, 95, 109, 110, 111, 128, 129, 147, 155, 168, and 180.

As red pigments, there are given colcothar, condensed azo compounds, such as Permanent Red 4R, lithol red, pyrazolone red, watching red calcium salt, Lake Red C, Lake Red D, Brilliant Carmine 6B, Brilliant Carmine 3B, eosin lake, rhodamine lake B, and alizarin lake, diketopyrrolopyrrole compounds, anthraquinone compounds, quinacridone compounds, basic dye lake compounds, naphthol compounds, benzimidazolone compounds, thioindigo compounds, and perylene compounds. Specific examples thereof include the following pigments:
C.I. Pigment Red 2, 3, 5, 6, 7, 23, 48:2, 48:3, 48:4, 57:1, 81:1, 122, 144, 146, 166, 169, 177, 184, 185, 202, 206, 220, 221, and 254.

As blue pigments, there are given alkali blue lake, Victoria Blue Lake, phthalocyanine blue, metal-free phthalocyanine blue, partially chlorinated phthalocyanine blue, fast sky blue, copper phthalocyanine compounds such as indanthrene blue BG, and derivatives thereof, anthraquinone compounds, and basic dye lake compounds. Specific examples thereof include the following pigments:
C.I. Pigment Blue 1, 7, 15, 15:1, 15:2, 15:3, 15:4, 60, 62, and 66.

As black pigments, there are given carbon black and aniline black. Those colorants may be used alone or as a mixture thereof, and in the state of a solid solution.

The content of the colorant is preferably 3.0 to 15.0 parts by mass with respect to 100.0 parts by mass of the binder resin or the polymerizable monomer.

### <Charge Control Agent and Charge Control Resin>

The toner particles may each contain a charge control agent. A known charge control agent may be used as the charge control agent. In particular, a charge control agent having a high charging speed and being capable of stably maintaining a constant charge quantity is preferred.

Examples of the charge control agent that controls toner particles so that the particles may be negatively chargeable include the following agents:
as organometallic compounds and chelate compounds, a monoazo metal compound, an acetylacetone metal compound, and aromatic oxycarboxylic acid-, aromatic dicarboxylic acid-, oxycarboxylic acid-, and dicarboxylic acid-based metal compounds. Other examples thereof include aromatic oxycarboxylic acids, and aromatic monocarboxylic and polycarboxylic acids, and metal salts, anhydrides, or esters thereof, and phenol derivatives such as bisphenol. Further, there are given a urea derivative, a salicylic acid-based compound containing a metal, a naphthoic acid-based compound containing a metal, a boron compound, a quaternary ammonium salt, and a calixarene.

Meanwhile, examples of the charge control agent that controls toner particles so that the particles may be positively chargeable include the following agents: a modified nigrosine compound; a guanidine compound; an imidazole compound; quaternary ammonium tributylbenzylammonium-1-hydroxy-4-naphtosulfonate and tetrabutylammonium tetrafluoroborate, and onium salts that are analogs of the above-mentioned compounds such as a phosphonium salt, and lake pigments thereof; a triphenylmethane dye and a lake pigment thereof (examples of a laking agent include phosphotungstic acid, phosphomolybdic acid, phosphotungstic molybdic acid, tannic acid, lauric acid, gallic acid, a ferricyanide, and a ferrocyanide); a metal salt of a higher fatty acid; and a resin-based charge control agent.

The charge control agents may be incorporated alone or in combination thereof.

The content of the charge control agent is preferably 0.01 to 10.00 parts by mass with respect to 100.00 parts by mass of the binder resin or the polymerizable monomer.

### <External Additive>

The toner of the present disclosure contains a particle of a silicon atom-containing compound as an external additive. An organic silicon particle and a silica particle are each preferred as the silicon atom-containing compound.

In addition, the external additive preferably contains a hydrotalcite particle.

The hydrotalcite particle is generally represented by the following formula (HT):

M²⁺_{y}M³⁺ₓ(OH)₂Aⁿ⁻_{(x/n)}·mH₂O Formula (HT)

where 0<x≤0.5, y=1−x, and m≥0.

The M²⁺ and the M³⁺ represent divalent and trivalent metals, respectively.

The M²⁺ preferably represents at least one divalent metal ion selected from the group consisting of: Mg; Zn; Ca; Ba; Ni; Sr; Cu; and Fe. The M³⁺ preferably represents at least one trivalent metal ion selected from the group consisting of: Al; B; Ga; Fe; Co; and In. The M²⁺ and the M³⁺ preferably represent Mg and Al out of those ions, respectively.

Aⁿ⁻ represents an n-valent anion. Examples of Aⁿ⁻ include CO₃²⁻, OH⁻, Cl⁻, I⁻, F⁻, Br⁻, SO₄²⁻, HCO₃⁻; CH₃COO⁻, and NO₃⁻. Any of those anions may be present alone or a plurality of kinds thereof may be present simultaneously.

The hydrotalcite particle preferably contains a fluorine atom. There is no particular limitation on a method of preparing a hydrotalcite particle containing a fluorine atom, and the method is, for example, a method involving treating the hydrotalcite particle with a coupling treatment agent containing a fluorine atom or a method involving treating the hydrotalcite particle in an aqueous solution containing a fluoride ion. A method involving subjecting the hydrotalcite particle to wet treatment in an aqueous solution containing a fluoride ion is preferred from the viewpoint of uniform treatment.

In the present disclosure, it is preferred that magnesium be contained as the divalent metal ion M²⁺, and aluminum be contained as the trivalent metal ion M³⁺. That is, in the present disclosure, the hydrotalcite particle preferably contains a fluorine atom, a magnesium atom, and an aluminum atom.

### [Process Cartridge and Electrophotographic Apparatus]

The process cartridge according to the present disclosure integrally supports the electrophotographic photosensitive member described in the foregoing, the developing unit, and the cleaning unit, and is detachably attachable onto a main body of an electrophotographic apparatus.

In addition, the electrophotographic apparatus according to the present disclosure includes the process cartridge according to the present disclosure.

An example of the schematic configuration of an electrophotographic apparatus including a process cartridge including the electrophotographic photosensitive member described above is illustrated in FIGURE.

An electrophotographic photosensitive member 1 having a cylindrical shape is rotationally driven about a shaft 2 in an arrow direction at a predetermined peripheral speed. The surface of the electrophotographic photosensitive member 1 is charged to a predetermined positive or negative potential by a charging unit 3. Although a roller charging system based on a roller type charging member is illustrated in FIGURE, a charging system, such as a corona charging system, a proximity charging system, or an injection charging system, may be adopted.

The charged surface of the electrophotographic photosensitive member 1 is irradiated with exposure light 4 from an exposing unit (not shown), and hence an electrostatic latent image corresponding to target image information is formed thereon. The electrostatic latent image formed on the surface of the electrophotographic photosensitive member 1 is developed with toner stored in a developing unit 5, and a toner image is formed on the surface of the electrophotographic photosensitive member 1.

The toner image formed on the surface of the electrophotographic photosensitive member 1 is transferred onto a transfer material 7 by a transferring unit 6. The transfer material 7 onto which the toner image has been transferred is conveyed to a fixing unit 8, is subjected to treatment for fixing the toner image, and is printed out to the outside of the electrophotographic apparatus.

A process cartridge 11 includes a cleaning unit 9 for removing, with a cleaning blade, a deposit such as the toner remaining on the surface of the electrophotographic photosensitive member 1 after the transfer. The abutting strength of the cleaning blade per unit length in a longitudinal direction with respect to the surface of the electrophotographic photosensitive member 1 is preferably 0.196 to 0.490 N/cm. When the abutting strength is 0.196 N/cm or more, a high cleaning property can be obtained in the combination of the electrophotographic photosensitive member 1 and the toner described in the foregoing. In addition, when the abutting strength is 0.490 N/cm or less, the wear of the surface of the electrophotographic photosensitive member 1 and the breakage of the cleaning blade can be suppressed.

The electrophotographic apparatus may include an electricity-removing mechanism for subjecting the surface of the electrophotographic photosensitive member 1 to electricity-removing treatment with pre-exposure light 10 from a pre-exposing unit (not shown). In addition, a guiding unit 12 such as a rail may be arranged for detachably attaching the process cartridge 11 of the present disclosure onto the main body of the electrophotographic apparatus.

The process cartridge 11 according to the present disclosure may be used in, for example, a laser beam printer, an LED printer, and a copying machine.

According to the present disclosure, the process cartridge that can achieve both of high image quality and a high cleaning property during long-term use, and the electrophotographic apparatus including the process cartridge can be provided.

### EXAMPLES

The present disclosure is described in more detail below by way of Examples and Comparative Examples. The present disclosure is by no means limited to the following Examples, and various modifications may be made without departing from the gist of the present disclosure. In the description in the following Examples, “part(s)” is by mass unless otherwise specified.

The electrophotographic photosensitive member is hereinafter also simply referred to as “photosensitive member.”

### <Production of Support of Electrophotographic Photosensitive Member and Coating Liquid for Each Layer>

### [Preparation of Support]

A cylinder formed of an aluminum alloy (JIS-A3003, aluminum alloy) having an outer diameter of 24 mm, a length of 261 mm, and a thickness of 0.9 mm, whose surface had been roughly cut, was mounted onto an NC lathe. Subsequently, the aluminum alloy was subjected to tool bit cutting processing with a diamond sintered tool bit so as to have an outer diameter of 23.97 mm and a surface roughness Ra(S80) of 0.02 μm while the abutting angle of the diamond sintered tool bit with respect to an element tube was changed between 0° and 3°. Thus, a support was produced. The tool bit cutting processing was performed under the following conditions: the number of main axis revolutions of the lathe was set to 3,000 rpm, and the moving speed of the tool bit (tool bit feed rate) was changed with a program for repeatedly increasing and decreasing the feed rate. The tool bit feed rate was changed by 0.005 mm/revolution every 1.5 mm of processing distance between 0.340 mm/revolution and 0.360 mm/revolution.

ΔL on the outer peripheral surface of the support was measured to be 50 μm. Herein, ΔL was obtained by subjecting a profile curve of the outer peripheral surface of the support near its center to roughness measurement. The roughness measurement was performed with “Surfcom 1400D” (manufactured by Tokyo Seimitsu Co., Ltd.) in accordance with the JIS 1994 standard under the measurement conditions of a measurement length of 4.0 mm, a long wavelength cutoff λc of 0.8 mm (Gaussian), and a measurement speed of 0.3 mm/sec.

In addition, Ra(S80) is an arithmetic average roughness Ra obtained near the center of the outer peripheral surface of the support by roughness measurement performed with “Surfcom 1400D” (manufactured by Tokyo Seimitsu Co., Ltd.). The roughness measurement was performed in accordance with the JIS 2001 standard under the measurement conditions of a measurement length of 4.0 mm, a long wavelength cutoff λc of 0.8 mm (Gaussian), a short wavelength cutoff λs of 80 μm, and a measurement speed of 0.3 mm/sec.

### [Preparation of Coating Liquid for Undercoat Layer]

A coating liquid for an undercoat layer was prepared as described below. Rutile-type titanium oxide having an average primary particle diameter of 40 nm (product name: TTO-55 (N), manufactured by Ishihara Sangyo Kaisha, Ltd.), and 3 mass % of methyldimethoxysilane (product name: TSL8117, manufactured by Toshiba Silicone Co., Ltd.) with respect to the titanium oxide were mixed in a Henschel mixer to provide surface-treated titanium oxide. After that, the surface-treated titanium oxide was dispersed in a mixed solvent having a mass ratio “methanol/1-propanol” of 7/3 with a ball mill to prepare a dispersed slurry of the surface-treated titanium oxide.

The resultant dispersed slurry, a mixed solvent of methanol, 1-propanol, and toluene, and pellets of copolymerized polyamide were stirred and mixed while being heated. Thus, the polyamide pellets were dissolved. The copolymerized polyamide includes the following five components, and a compositional molar ratio of each component is as described below.
ε8-Caprolactam represented by the following formula (D): 60%
Bis(4-amino-3-methylcyclohexyl)methane represented by the following formula (E): 15%
Hexamethylenediamine represented by the following formula (F): 5%
Decamethylene dicarboxylic acid represented by the following formula (G): 15%
Octadecamethylene dicarboxylic acid represented by the following formula (H): 5%

After that, ultrasonic dispersion treatment was performed to prepare a coating liquid for an undercoat layer having a solid content concentration of 18.0%. The resultant coating liquid for an undercoat layer includes the surface-treated titanium oxide and the copolymerized polyamide at a mass ratio of 3/1 in the mixed solvent formed of methanol, 1-propanol, and toluene (at a mass ratio of 7/1/2).

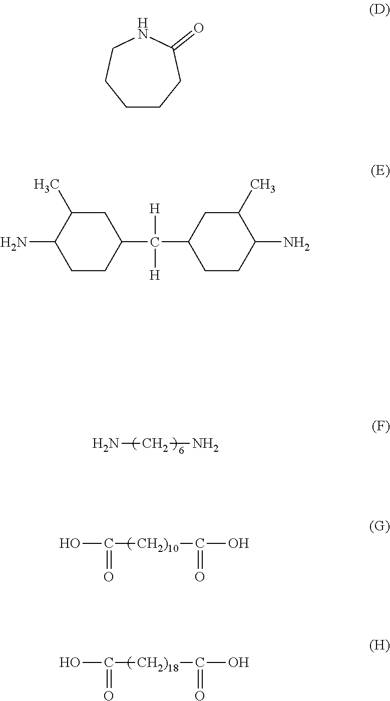

### [Preparation of Coating Liquid for Charge Generating Layer]

10 Parts of a Y-type oxytitanium phthalocyanine crystal having a strong peak at a Bragg angle (2θ±0.2°) in CuKα characteristic X-ray diffraction of 27.3° was prepared as a charge generating substance. The charge generating substance and 150 parts of 4-methoxy-4-methyl-2-pentanone were loaded in a sand mill using glass beads each having a diameter of 1 mm, and were subjected to pulverization and dispersion treatment with a sand grind mill for 1.5 hours. Next, 105 parts of a solution obtained by dissolving 5 parts of a polyacetal resin (product name: S-LEC BX-1, manufactured by Sekisui Chemical Co., Ltd.) in 100 parts of 4-methoxy-4-methyl-2-pentanone was added to the sand mill, and the resultant mixture was subjected to dispersion treatment for 0.5 hour. After that, 250 parts of 1,2-dimethoxyethane was further added to the sand mill to prepare a coating liquid for a charge generating layer.

The X-ray diffraction measurement was performed under the following conditions.

### [Powder X-Ray Diffraction Measurement]

Measurement apparatus used: X-ray diffraction apparatus RINT-TTRII manufactured by Rigaku Denki Co., Ltd.
X-ray tube bulb: Cu
Tube voltage: 50 KV
Tube current: 300 mA
Scan method: 2θ/θ scan
Scan speed: 4.0°/min
Sampling interval: 0.02°
Start angle (2θ): 5.0°
Stop angle (2θ): 40.0°
Attachment: standard sample holder
Filter: not used
Incident monochrometer: used
Counter monochrometer: not used
Divergent slit: open
Divergent longitudinal restriction slit: 10.00 mm
Scattering slit: open
Light receiving slit: open
Flat sheet monochrometer: used
Counter: scintillation counter

### [Production Example of Polycarbonate Resin]

### <Production Example of Polycarbonate Resin P1>

The following materials were prepared.
Compound represented by the following formula (B-1): 677.00 g (2.52 mol)
Compound represented by the following formula (B-2): 180.18 g (0.84 mol)
Compound represented by the following formula (B-3): 180.18 g (0.84 mol)
Triethylbenzylammonium chloride: 0.4 g
Hydrosulfite: 5.0 g

Those materials were dissolved in 5.4 L of a 9.0 w/w% sodium hydroxide (NaOH) aqueous solution. 2.4 L of methylene chloride was added to the solution, and the temperature of the mixture was maintained at 15° C. while the mixture was stirred. Subsequently, during the temperature maintenance, 540 g of phosgene was blown into the mixture over 30 minutes. After the completion of the blowing of phosgene, 21 g of p-t-butylphenol was added to the reaction liquid, and the reaction liquid was vigorously stirred to be emulsified. After the emulsification, 11 ml of triethylamine was added to the emulsified product, and the mixture was stirred at a temperature of from 20° C. to 25° C. for about 1 hour to be polymerized.

After the completion of the polymerization, the reaction liquid was separated into an aqueous phase and an organic phase, and the organic phase was neutralized with phosphoric acid. The organic phase was repeatedly washed with water until the conductivity of washing water became 10 μS/cm or less. The resultant organic phase was dropped in warm water kept at 62° C., and the solvent was removed by evaporation. Thus, a white powdery precipitate was obtained. The resultant precipitate was filtered out, and was dried at a temperature of 120° C. for 24 hours to provide a target polycarbonate resin P1.

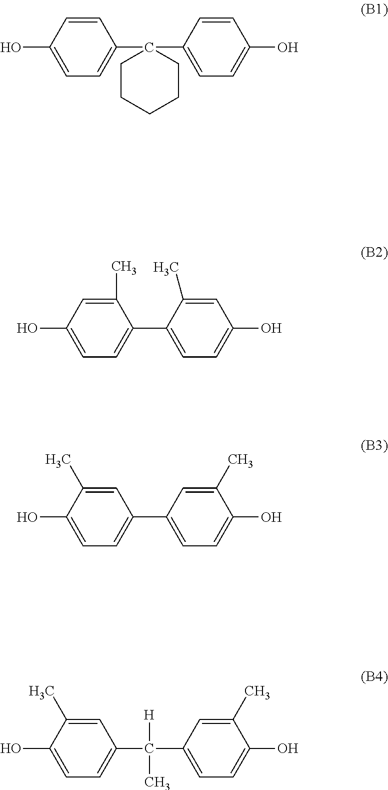 [SMILES: Oc1ccc(C2(c3ccc(O)cc3)CCCCC2)cc1 ; Cc1cc(O)ccc1-c1ccc(O)cc1C ; Cc1cc(-c2ccc(O)c(C)c2)ccc1O ; Cc1cc(C(C)c2ccc(O)c(C)c2)ccc1O]

### <Production Examples of Polycarbonate Resins P2 to P18>

Polycarbonate resins P2 to P18 were each produced in the same manner as in the polycarbonate resin P1 except that, in the production example of the polycarbonate resin P1, the copolymerization units of the polycarbonate resin to be used were changed to the compounds shown in Table 1, and the compounds were used at molar ratios shown in Table 1.

TABLE 1

Copolymerization unit ratio (mol %)

| Polycarbonate | Formula | Formula | Formula | Formula |
|---|---|---|---|---|
| resin | (B1) | (B2) | (B3) | (B4) |
| P1 | 50 | 25 | 25 | 0 |
| P2 | 60 | 20 | 20 | 0 |
| P3 | 40 | 30 | 30 | 0 |
| P4 | 50 | 20 | 30 | 0 |
| P5 | 50 | 30 | 20 | 0 |
| P6 | 60 | 16 | 24 | 0 |
| P7 | 60 | 24 | 16 | 0 |
| P8 | 50 | 15 | 35 | 0 |
| P9 | 50 | 35 | 15 | 0 |
| P10 | 70 | 15 | 15 | 0 |
| P11 | 30 | 35 | 35 | 0 |
| P12 | 70 | 21 | 9 | 0 |
| P13 | 30 | 21 | 49 | 0 |
| P14 | 100 | 0 | 0 | 0 |
| P15 | 0 | 50 | 50 | 0 |
| P16 | 0 | 80 | 20 | 0 |
| P17 | 0 | 20 | 80 | 0 |
| P18 | 50 | 0 | 0 | 50 |

### [Preparation of Coating Liquid 1 for Charge Transporting Layer]

The following materials were prepared.
Charge transporting substance (hole-transportable substance) CTM10: 10 parts
Polycarbonate resin (P1): 10 parts

A coating liquid 1 for a charge transporting layer was prepared by dissolving those compounds in a mixed solvent of 55 parts of toluene and 45 parts of tetrahydrofuran.

### [Preparation of Coating Liquids 2 to 19 for Charge Transporting Layers]

Coating liquids 2 to 19 for charge transporting layers were each prepared by the same method as that of the coating liquid 1 for a charge transporting layer except that the kind and amount of the polycarbonate resin were changed as shown in Table 2.

TABLE 2

| | Polycarbonate resin | |
|---|---|---|
| | Kind | Molar ratio (%) |
| Coating liquid 1 for charge transporting layer | P1 | 100 |
| Coating liquid 2 for charge transporting layer | P2 | 100 |
| Coating liquid 3 for charge transporting layer | P3 | 100 |
| Coating liquid 4 for charge transporting layer | P4 | 100 |
| Coating liquid 5 for charge transporting layer | P5 | 100 |
| Coating liquid 6 for charge transporting layer | P6 | 100 |
| Coating liquid 7 for charge transporting layer | P7 | 100 |
| Coating liquid 8 for charge transporting layer | P8 | 100 |
| Coating liquid 9 for charge transporting layer | P9 | 100 |
| Coating liquid 10 for charge transporting layer | P10 | 100 |
| Coating liquid 11 for charge transporting layer | P11 | 100 |
| Coating liquid 12 for charge transporting layer | P12 | 100 |
| Coating liquid 13 for charge transporting layer | P13 | 100 |
| Coating liquid 14 for charge transporting layer | P14 | 50 |
| | P15 | 50 |
| Coating liquid 15 for charge transporting layer | P10 | 70 |
| | P15 | 30 |
| Coating liquid 16 for charge transporting layer | P18 | 100 |
| Coating liquid 17 for charge transporting layer | P15 | 100 |
| Coating liquid 18 for charge transporting layer | P16 | 100 |
| Coating liquid 19 for charge transporting layer | P17 | 100 |

### <Production of Electrophotographic Photosensitive Member>

### [Production of Photosensitive Member 1]

The coating liquid for an undercoat layer prepared in the foregoing was applied onto the support by dip coating, and was dried at 100° C. for 10 minutes to form an undercoat layer having a thickness of 2.0 μm.

The coating liquid for a charge generating layer prepared in the foregoing was applied onto the resultant undercoat layer by dip coating, and was dried at 100° C. for 10 minutes to form a charge generating layer having a thickness of 0.15 μm.

The coating liquid 1 for a charge transporting layer prepared in the foregoing was applied onto the resultant charge generating layer by dip coating, and was dried at 120° C. for 30 minutes to form a charge transporting layer having a thickness of 16.0 μm.

Thus, a photosensitive member 1 was produced.

### [Photosensitive Members 2 to 19]

Photosensitive members 2 to 19 were each produced in the same manner as in the photosensitive member 1 except that, in the production of the photosensitive member 1, the kind of the coating liquid for a charge transporting layer to be used was changed as shown in Table 3.

TABLE 3

| Photosensitive member | Coating liquid for charge transporting layer |
|---|---|
| Photosensitive member 1 | Coating liquid 1 for charge transporting layer |
| Photosensitive member 2 | Coating liquid 2 for charge transporting layer |
| Photosensitive member 3 | Coating liquid 3 for charge transporting layer |
| Photosensitive member 4 | Coating liquid 4 for charge transporting layer |
| Photosensitive member 5 | Coating liquid 5 for charge transporting layer |
| Photosensitive member 6 | Coating liquid 6 for charge transporting layer |
| Photosensitive member 7 | Coating liquid 7 for charge transporting layer |
| Photosensitive member 8 | Coating liquid 8 for charge transporting layer |
| Photosensitive member 9 | Coating liquid 9 for charge transporting layer |
| Photosensitive member | Coating liquid 10 for charge transporting layer |
| 10 | |
| Photosensitive member | Coating liquid 11 for charge transporting layer |
| 11 | |
| Photosensitive member | Coating liquid 12 for charge transporting layer |
| 12 | |
| Photosensitive member | Coating liquid 13 for charge transporting layer |
| 13 | |
| Photosensitive member | Coating liquid 14 for charge transporting layer |
| 14 | |
| Photosensitive member | Coating liquid 15 for charge transporting layer |
| 15 | |
| Photosensitive member | Coating liquid 16 for charge transporting layer |
| 16 | |
| Photosensitive member | Coating liquid 17 for charge transporting layer |
| 17 | |
| Photosensitive member | Coating liquid 18 for charge transporting layer |
| 18 | |
| Photosensitive member | Coating liquid 19 for charge transporting layer |
| 19 | |

### <Production Examples of Toners>

Production examples of toners used in Examples and Comparative Examples are described below.

Although toner particles produced by an emulsion polymerization aggregation method were used in Examples of the present disclosure, the toner particles in the present disclosure are not necessarily limited thereto, and toner particles obtained by a pulverization method, a suspension polymerization method, or a dissolution suspension method may also be used.

### <Preparation of Colorant Dispersion Liquid>

50 Parts by mass of carbon black (specific surface area based on a BET method: 60 m²/g), 3 parts by mass of an anionic surfactant (NEOGEN RK, DKS Co. Ltd.), and 400 parts by mass of ion-exchanged water were mixed. The resultant mixture was dispersed with a homogenizer (manufactured by IKA: ULTRA-TURRAX) to provide a colorant dispersion liquid.

### <Preparation of Resin Particle Dispersion Liquid>

7 Parts by mass of a nonionic surfactant (manufactured by Sanyo Chemical Industries, Ltd.: NONIPOL) and 10 parts by mass of an anionic surfactant (manufactured by DKS Co., Ltd.: NEOGEN RK) were dissolved in 520 parts by mass of ion-exchanged water to prepare a surfactant solution. A solution prepared by mixing in advance and dissolving the surfactant solution, 280 parts by mass of styrene, 100 parts by mass of n-butyl acrylate, 7 parts by mass of acrylic acid, and 15 parts by mass of a charge control agent BONTRON E-88 (manufactured by Orient Chemical Industries Co., Ltd.) was loaded in a flask, and was emulsified. While the resultant was slowly stirred for 10 minutes, 70 parts by mass of ion-exchanged water in which 3 parts by mass of ammonium persulfate was dissolved was further loaded thereinto. After nitrogen replacement was thoroughly performed, the contents were heated in an oil bath until their temperature reached 70° C. while the flask was stirred, and the emulsion polymerization was continued as it was for 6 hours.

After that, the reaction liquid was cooled to room temperature to provide a resin particle dispersion liquid having a weight-average particle diameter (D4) of 150 nm and a glass transition temperature of 57.0° C.

A Microtrac particle size distribution-measuring apparatus (manufactured by Nikkiso Co., Ltd.) was used in the measurement of the weight-average particle diameter. The measurement with the Microtrac particle size distribution-measuring apparatus was performed under the conditions of: measurement range=0.12 μm to 704 μm; measurement time=30 seconds; and medium=ion-exchanged water.

### <Preparation of Releasing Agent Dispersion Liquid>

200 Parts by mass of pentaerythritol behenic acid serving as a releasing agent, 3 parts by mass of an anionic surfactant (manufactured by Takemoto Oil & Fat Co., Ltd.: Pionin A-45-D), and 700 parts by mass of ion-exchanged water were mixed. The resultant mixture was dispersed through use of a homogenizer (manufactured by IKA: ULTRA-TURRAX), and was then subjected to dispersion treatment with a pressure ejection homogenizer to provide a releasing agent dispersion liquid.

### <Production of Toner Particles>

The following materials were prepared.
Resin particle dispersion liquid: 300 parts by mass
Colorant dispersion liquid: 200 parts by mass
Releasing agent dispersion liquid: 100 parts by mass
Cationic surfactant (manufactured by Kao Corporation: SANISOL B-50): 3 parts by mass
Ion-exchanged water: 500 parts by mass

The above-mentioned respective components were mixed and dispersed in a round-bottomed stainless-steel flask through use of a homogenizer (manufactured by IKA, ULTRA-TURRAX T50). After that, the pH of the mixture was adjusted, and the mixture was heated to 50° C. under stirring in an oil bath for heating and held at 50° C. for 30 minutes to form aggregated particles. 30 Parts of the resin particle dispersion liquid was added to the liquid of the aggregated particles, and the resultant was further heated and stirred at 50° C. for 3 hours.

Next, 6 parts of sodium dodecylbenzenesulfonate (manufactured by DKS Co., Ltd.: NEOGEN SC) serving as an anionic surfactant was added to the dispersion liquid, and the mixture was heated to 95° C. and held as it was for 9 hours. Thus, the aggregated particles were fused to each other. After that, the resultant was cooled to 50° C. at a temperature decrease rate of 0.3° C./min, was filtered out, and was then thoroughly washed with ion-exchanged water. After that, the resultant was further filtered out through a 400-mesh sieve to provide fused particles. The resultant fused particles were dried with a vacuum dryer to provide toner particles.

### <Preparation of External Additive>

Each of the following commercially available products and compounds prepared as described below was used as an external additive.

### <External Additive 1>

Silica particles (RX200: primary average particle diameter: 12 nm, HMDS treatment, manufactured by Nippon Aerosil Co., Ltd.) were used as an external additive 1.

### <Preparation of External Additive 2>

Metatitanic acid produced by a sulfuric acid method was subjected to deironizing bleaching treatment, and then a 3 mol/L sodium hydroxide aqueous solution was added thereto to adjust its pH to 9.0, followed by desulfurization treatment. After that, the resultant was neutralized to a pH of 5.6 with 5 mol/L hydrochloric acid, and was filtered out and washed with water. Water was added to the washed cake to form a 1.90 mol/L slurry as TiO₂. After that, hydrochloric acid was added to the slurry to adjust its pH to 1.4, and the resultant was subjected to deflocculation treatment.

1.90 Moles of the desulfurized and deflocculated metatitanic acid was collected as TiO₂ and loaded into a 3 L reaction vessel. A strontium chloride aqueous solution was added as SrO to the deflocculated metatitanic acid slurry so that SrO/TiO₂ (molar ratio) became 1.15 and so that the number of moles thereof became 2.185 mol. Then, the concentration of TiO₂ was adjusted to 1.039 mol/L. Next, the resultant was heated to 90° C. under stirring and mixing. Then, 440 mL of a 10 mol/L sodium hydroxide aqueous solution was added to the resultant over 40 minutes. After that, stirring was continued at 95° C. for 45 minutes, and then the resultant was rapidly cooled by being loaded into ice water. Thus, the reaction was completed.

The reaction slurry was heated to 70° C., and 12 mol/L hydrochloric acid was added until its pH became 5.0. Stirring was continued for 1 hour, and the resultant precipitate was decanted.

The temperature of the slurry containing the resultant precipitate was adjusted to 40° C., and hydrochloric acid was added thereto to adjust its pH to 2.5. Then, 4.6 mass % of isobutyltrimethoxysilane and 4.6 mass % of trifluoropropyltrimethoxysilane were added with respect to the solid content, and stirring was performed for 10 hours. A 5 mol/L sodium hydroxide aqueous solution was added to the mixture to adjust its pH to 6.5, and stirring was continued for 1 hour. Then, filtration and washing were performed, and the resultant cake was dried in an atmosphere at 120° C. for 8 hours, followed by pulverization treatment to provide strontium titanate particles. The resultant strontium titanate particles were defined as an external additive 2.

### <Preparation of External Additive 3>

A mixed aqueous solution (solution A) of 1.03 mol/L magnesium chloride and 0.239 mol/L aluminum sulfate, a 0.753 mol/L sodium carbonate aqueous solution (solution B), and a 3.39 mol/L sodium hydroxide aqueous solution (solution C) were prepared.

Next, the solution A, the solution B, and the solution C were injected into a reaction vessel with a metering pump at such a flow rate that the volume ratio “solution A:solution B” became 4.5:1, and the pH value of the reaction solution was kept in the range of from 9.3 to 9.6 with the solution C. The reaction was performed at 40° C. to generate a precipitate. After filtration and washing, the resultant was subjected to re-emulsification in ion-exchanged water to provide a hydrotalcite slurry as a raw material. The concentration of hydrotalcite in the resultant hydrotalcite slurry was 5.6 mass %.

The resultant hydrotalcite slurry was dried in a vacuum overnight at 40° C. NaF was dissolved in ion-exchanged water so that its concentration became 100 mg/L, followed by the adjustment of the pH of the resultant to 7.0 with 1 mol/L HCl or 1 mol/L NaOH. Thus, a solution was produced. The dried hydrotalcite was added thereto at 0.1% (w/v %). Constant-speed stirring was performed with a magnetic stirrer for 48 hours to the degree that the hydrotalcite was not settled out. After that, the resultant was filtered through a membrane filter having a pore diameter of 0.5 μm and washed with ion-exchanged water. The resultant hydrotalcite was dried in a vacuum overnight at 40° C. and then subjected to shredding treatment. The resultant hydrotalcite particles were defined as an external additive 3.

### <Preparation of External Additive 4>

An external additive 4 was obtained in the same manner as in the production example of the external additive 3 except that, in the production example of the external additive 3, ion-exchanged water was used instead of the NaF aqueous solution.

### <Preparation of External Additive 5>

43.0 g of RO water and 0.008 g of acetic acid serving as a catalyst were loaded into a 200 ml beaker and stirred at 45° C. 54.0 g of trimethoxymethylsilane was added to the resultant, followed by stirring for 1.5 hours. Thus, a raw material solution was obtained. 70.0 g of RO water, 340.0 g of methanol, and 1.8 g of 25% ammonia water were loaded into a 1,000 ml beaker, followed by stirring at 30° C. Thus, an alkaline aqueous medium was prepared. The raw material solution was dropped over 1 minute into the alkaline aqueous medium. A polycondensation reaction was advanced by stirring the mixed liquid after the dropping of the raw material solution for 1.5 hours while keeping the mixed liquid as it was at 30° C. Thus, a polycondensation reaction liquid was obtained. 700 g of RO water was loaded into a 2,000 ml beaker, and the polycondensation reaction liquid was dropped over 10 minutes into the water under stirring at 25° C. A propeller having a diameter of φ50 mm was used for the stirring, and its rotation speed was set to 200 rpm. The polycondensation reaction liquid immediately became cloudy when mixed with water. Thus, a dispersion liquid containing an organic silicon polymer particle having a siloxane bond was obtained. To the dispersion liquid, 23 g of hexamethyldisilazane was added as a hydrophobizing agent, and the mixture was stirred at 60° C for 2.5 hours. After the resultant was left to stand still for 5 minutes, powder precipitated in a lower part of the solution was collected by suction filtration and dried under reduced pressure at 120° C. for 24 hours to provide an external additive 5.

### <Production of Toner 1>

The external additive 1, the external additive 2, and the external additive 3 were mixed with a Henschel mixer at ratios of 2.0 parts, 0.25 part, and 0.30 part, respectively, with respect to 100 parts by mass of the toner particles to provide a toner 1.

### <Production of Toners 2 to 8>

Toners 2 to 8 were each obtained in the same manner as in the toner 1 except that the kinds and amounts of the external additives to be used were changed as shown in Table 4.

TABLE 4

| | Ratio (mass %) of particle | | |
|---|---|---|---|
| | of silicon atom-containing | External additive | Use amount |
| | compound | Kind | (part(s)) |
| Toner 1 | 2.0% | External additive 1 | 2.0 |
| | | External additive 2 | 0.25 |
| | | External additive 3 | 0.30 |
| Toner 2 | 2.5% | External additive 1 | 2.5 |
| | | External additive 2 | 0.25 |
| | | External additive 3 | 0.30 |
| Toner 3 | 3.0% | External additive 1 | 3.0 |
| | | External additive 2 | 0.25 |
| | | External additive 3 | 0.30 |
| Toner 4 | 2.5% | External additive 1 | 2.5 |
| | | External additive 2 | 0.20 |
| | | External additive 4 | 0.50 |
| Toner 5 | 2.5% | External additive 1 | 2.5 |
| | | External additive 2 | 0.20 |
| Toner 6 | 2.5% | External additive 5 | 2.5 |
| | | External additive 2 | 0.20 |
| Toner 7 | 1.7% | External additive 1 | 1.7 |
| | | External additive 2 | 0.20 |
| | | External additive 3 | 0.40 |
| Toner 8 | 3.2% | External additive 1 | 3.2 |
| | | External additive 2 | 0.30 |
| | | External additive 3 | 0.60 |

### Example 1

A reconstructed machine of a laser beam printer (product name: HP Color LaserJet CP4525dn) manufactured by Hewlett-Packard Company was used as an electrophotographic apparatus. The laser beam printer was reconstructed so that a voltage to be applied to its charging roller was able to be regulated and measured, an image exposure light quantity was able to be regulated and measured, and the abutting pressure of the cleaning blade with the electrophotographic photosensitive member was able to be adjusted.

In addition, the cyan cartridge of the apparatus was reconstructed, the photosensitive member built therein was replaced with the photosensitive member 1, and the toner built therein was replaced with the toner 1.

### Examples 2 to 26 and Comparative Examples 1 to 6

Process cartridges according to Examples 2 to 26 and Comparative Examples 1 to 6 were each prepared in the same manner as in Example 1 except that in Example 1, the kinds of the photosensitive member and the toner to be used were changed as shown in Table 5.

### [Evaluation]

Evaluations were performed by using each of the process cartridges according to Examples 1 to 26 and Comparative Examples 1 to 6 under the following conditions.

### Evaluation of Fogging

In the measurement of fogging, the above-mentioned evaluation machine was used as an image forming apparatus. An A4 size CLC sheet (manufactured by Canon Inc., basis weight: 80 g/m²) was used as a transfer material used in an endurance test. The endurance test was performed with a system in which printing was stopped for 1 minute each time the printing was performed on 2 sheets at a print percentage of 1% under a normal-temperature and normal-humidity environment (a temperature of 23.5° C. and a humidity of 60% RH). After printing on 15,000 sheets from the initial state, the sheet was left to stand for 6 days. After that, the reflectance of the image sample on the first sheet was measured with REFLECTOMETER MODEL TC-6DS manufactured by Tokyo Denshoku Co., Ltd. Meanwhile, the reflectance of transfer paper before the formation of the white image was similarly measured after the paper had been left to stand for 6 days. As a filter, a green filter was used.

Fogging was calculated from the reflectances before and after the output of the white image using the following equation.

Fogging (reflectance) (%)=reflectance (%) of transfer paper-reflectance (%) of white image

Evaluation criteria for the fogging are as described below. A rank C or more was judged to be satisfactory.
A: Less than 0.5%
B: 0.5% or more and less than 1.5%
C: 1.5% or more and less than 3.0%
D: 3.0% or more

The evaluation results are shown in Table 5.

### Evaluation of Image Streak

As a charging condition, a dark portion potential was adjusted to −500 V, and as an exposure condition, the image exposure light quantity was adjusted to 0.25 μJ/cm². Further, an evaluation was performed by using a halftone image immediately after the output of a horizontal line image in which lines were drawn at intervals of 10 spaces on 1,000 sheets. Specifically, the number of escapes (streaks) occurring in the output image, which were considered to be cleaning failures, was visually counted, and a rank evaluation was performed. Evaluation criteria for the image streak are as described below.
A: No streak in terms of image quality is present, and hence image quality is satisfactory.
B: A slight streak occurs.
C: A streak occurs in part of the image.
D: A streak occurs in the entirety of the image.

The evaluation results are shown in Table 5.

TABLE 5

| | | | C blade | | |
|---|---|---|---|---|---|
| | | | abutting | Fogging | Image streak |
| | Photosensitive member | Toner | pressure | evaluation | evaluation |
| Example 1 | Photosensitive member 1 | Toner 1 | 0.3N | A | A |
| Example 2 | Photosensitive member 2 | Toner 1 | 0.3N | A | A |
| Example 3 | Photosensitive member 3 | Toner 1 | 0.3N | A | A |
| Example 4 | Photosensitive member 4 | Toner 1 | 0.3N | A | A |
| Example 5 | Photosensitive member 5 | Toner 1 | 0.3N | A | A |
| Example 6 | Photosensitive member 6 | Toner 1 | 0.3N | A | A |
| Example 7 | Photosensitive member 7 | Toner 1 | 0.3N | A | A |
| Example 8 | Photosensitive member 1 | Toner 1 | 0.2N | A | A |
| Example 9 | Photosensitive member 8 | Toner 1 | 0.3N | A | B |
| Example 10 | Photosensitive member 9 | Toner 1 | 0.3N | A | B |
| Example 11 | Photosensitive member 10 | Toner 1 | 0.3N | A | B |
| Example 12 | Photosensitive member 11 | Toner 1 | 0.3N | A | B |
| Example 13 | Photosensitive member 12 | Toner 1 | 0.3N | A | B |
| Example 14 | Photosensitive member 13 | Toner 1 | 0.3N | A | B |
| Example 15 | Photosensitive member 14 | Toner 1 | 0.3N | A | A |
| Example 16 | Photosensitive member 15 | Toner 1 | 0.3N | A | A |
| Example 17 | Photosensitive member 1 | Toner 2 | 0.3N | A | A |
| Example 18 | Photosensitive member 1 | Toner 3 | 0.3N | A | A |
| Example 19 | Photosensitive member 1 | Toner 4 | 0.3N | A | B |
| Example 20 | Photosensitive member 1 | Toner 5 | 0.3N | A | C |
| Example 21 | Photosensitive member 1 | Toner 6 | 0.3N | B | C |
| Example 22 | Photosensitive member 1 | Toner 1 | 0.18N | A | B |
| Example 23 | Photosensitive member 1 | Toner 1 | 0.50N | A | D |
| Example 24 | Photosensitive member 8 | Toner 6 | 0.18N | B | C |
| Example 25 | Photosensitive member 10 | Toner 6 | 0.18N | C | C |
| Example 26 | Photosensitive member 12 | Toner 6 | 0.18N | C | C |
| Comparative | Photosensitive member 16 | Toner 1 | 0.3N | A | D |
| Example 1 | | | | | |
| Comparative | Photosensitive member 17 | Toner 1 | 0.3N | A | D |
| Example 2 | | | | | |
| Comparative | Photosensitive member 18 | Toner 1 | 0.3N | A | D |
| Example 3 | | | | | |
| Comparative | Photosensitive member 19 | Toner 1 | 0.3N | A | D |
| Example 4 | | | | | |
| Comparative | Photosensitive member 1 | Toner 7 | 0.3N | D | C |
| Example 5 | | | | | |
| Comparative | Photosensitive member 1 | Toner 8 | 0.3N | A | C |
| Example 6 | | | | | |

In Table 5, the “C blade” refers to the cleaning blade.

In Example 23, the torque became excessive to cause chipping on the cleaning blade, and hence the image streak evaluation became poor.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-188612, filed Nov. 25, 2022, which is hereby incorporated by reference herein in its entirety.

What is claimed is:

1. A process cartridge comprising:
an electrophotographic photosensitive member comprising a surface layer;
a developing unit configured to develop an electrostatic latent image formed on a surface of the electrophotographic photosensitive member with toner to form a toner image on the surface of the electrophotographic photosensitive member; and
a cleaning unit configured to remove the toner remaining on the surface of the electrophotographic photosensitive member with a cleaning blade after the toner image is transferred to a transfer material,
the process cartridge integrally supporting the electrophotographic photosensitive member, the developing unit, and the cleaning unit, and being detachably attachable onto a main body of an electrophotographic apparatus,
wherein the surface layer of the electrophotographic photosensitive member comprises a polycarbonate resin having a structural unit represented by the following formula (1), a structural unit represented by the following formula (2), and a structural unit represented by the following formula (3), 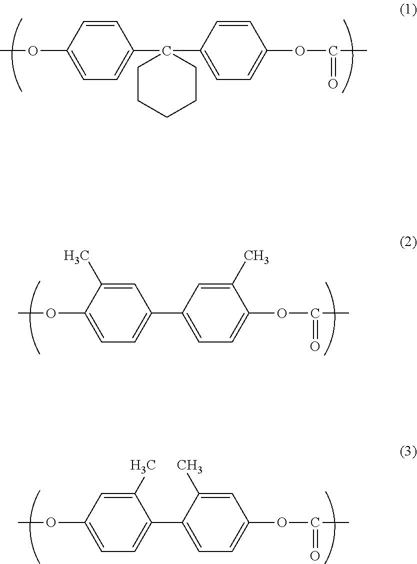
wherein the toner contains: a toner particle containing a resin; and an external additive,
wherein the external additive contains a particle of a silicon atom-containing compound, and
wherein a content ratio of the particle of the silicon atom-containing compound in the toner is 2.0 to 3.0 mass % with respect to a total mass of the toner.

2. A process cartridge comprising:
an electrophotographic photosensitive member comprising a surface layer;
a developing unit configured to develop an electrostatic latent image formed on a surface of the electrophotographic photosensitive member with toner to form a toner image on the surface of the electrophotographic photosensitive member; and
a cleaning unit configured to remove the toner remaining on the surface of the electrophotographic photosensitive member with a cleaning blade after the toner image is transferred to a transfer material,
the process cartridge integrally supporting the electrophotographic photosensitive member, the developing unit, and the cleaning unit, and being detachably attachable onto a main body of an electrophotographic apparatus,
wherein a total ion chromatogram (TIC) obtained by subjecting a polymer component recovered from the surface layer of the electrophotographic photosensitive member to pyrolysis-gas chromatography-mass spectrometry under coexistence with tetramethylammonium hydroxide (TMAH) has a mass spectrum including components satisfying at least m/z=242 and m/z=227, and a mass spectrum including components satisfying at least m/z=296, m/z=253, m/z=145, and m/z=121,
wherein the polymer component has peaks at 2.35±0.02 ppm and 2.40±0.02 ppm in a ¹H-nuclear magnetic resonance spectrum with deuterated chloroform,
wherein the toner contains: a toner particle containing a resin; and an external additive,
wherein the external additive contains a particle of a silicon atom-containing compound, and
wherein a content ratio of the particle of the silicon atom-containing compound in the toner is 2.0 to 3.0 mass % with respect to a total mass of the toner.

3. The process cartridge according to claim 1, wherein, in the polycarbonate resin, a content ratio of the structural unit represented by the formula (2) is 40 to 60 mol % with respect to a total of a content of the structural unit represented by the formula (2) and a content of the structural unit represented by the formula (3).

4. The process cartridge according to claim 1, wherein, in the polycarbonate resin, a total content ratio of a content of the structural unit represented by the formula (2) and a content of the structural unit represented by the formula (3) is 40 to 60 mol % with respect to a total of a content of the structural unit represented by the formula (1), the content of the structural unit represented by the formula (2), and the content of the structural unit represented by the formula (3).

5. The process cartridge according to claim 1, wherein the particle of the silicon atom-containing compound is a silica particle.

6. The process cartridge according to claim 1, wherein the external additive contains a hydrotalcite particle.

7. The process cartridge according to claim 6, wherein the hydrotalcite particle contains a fluorine atom.

8. The process cartridge according to claim 1, wherein the cleaning blade has an abutting strength per unit length in a longitudinal direction with respect to the surface of the electrophotographic photosensitive member of 0.196 to 0.490 N/cm.

9. An electrophotographic apparatus comprising a process cartridge,
the process cartridge comprising:
an electrophotographic photosensitive member comprising a surface layer;
a developing unit configured to develop an electrostatic latent image formed on a surface of the electrophotographic photosensitive member with toner to form a toner image on the surface of the electrophotographic photosensitive member; and
a cleaning unit configured to remove the toner remaining on the surface of the electrophotographic photosensitive member with a cleaning blade after the toner image is transferred to a transfer material,
the process cartridge integrally supporting the electrophotographic photosensitive member, the developing unit, and the cleaning unit, and being detachably attachable onto a main body of an electrophotographic apparatus,
wherein the surface layer of the electrophotographic photosensitive member comprises a polycarbonate resin having a structural unit represented by the following formula (1), a structural unit represented by the following formula (2), and a structural unit represented by the following formula (3), 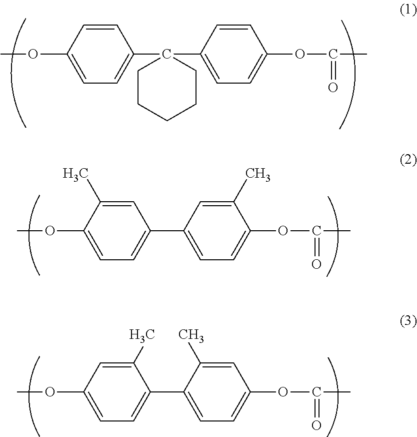
wherein the toner contains: a toner particle containing a resin; and an external additive,
wherein the external additive contains a particle of a silicon atom-containing compound, and
wherein a content ratio of the particle of the silicon atom-containing compound in the toner is 2.0 to 3.0 mass % with respect to a total mass of the toner.
